(19) United States
(12) Patent Application Publication
(10) Pub. No.: US 2016/0363094 A1
(43) Pub. Date: Dec. 15, 2016

(54) SPARK PLUG ASSEMBLY HAVING IMPROVED COOLING

(71) Applicant: Caterpillar Inc., Peoria, IL (US)

(72) Inventors: Aaron C. LUFT, Frankfort, IN (US); James CRESS, West Lafayette, IN (US); Jeff Allen Howard, West Lafayette, IN (US); Joshua Andrew HYDE, West Lafayette, IN (US); Parthipan SUBRAMANIAN, Chennai (IN)

(73) Assignee: CATERPILLAR INC., Peoria, IL (US)

(21) Appl. No.: 14/740,151

(22) Filed: Jun. 15, 2015

(51) Int. Cl. F02F 1/36; F02F 1/24; F02F 11/00; F02P 13/00

(52) U.S. Cl. CPC F02F 1/36; F02P 13/00; F02F 1/242; F02F 11/002

(57) ABSTRACT

A spark plug assembly is disclosed for use with an engine having a cylinder head at feast partially defining a combustion chamber. The spark plug assembly may have a spark plug at least partially disposed in the cylinder head and configured to generate a spark Inside the combustion chamber to ignite an air and fuel mixture. The spark plug assembly may also have an insert configured to receive the spark plug and at least partially form a cooling passage surrounding the spark plug.

### TECHNICAL FIELD

The present disclosure relates generally to a spark plug assembly and, more particularly, to a spark plug assembly having improved cooling.

Engines, including diesel engines, gasoline engines, gaseous fuel powered engines, and other engines known in the art ignite or admit an air and fuel mixture to produce heat. Fuel directed into a combustion chamber of the engine can be ignited by way of a spark plug, a glow plug, or an AC/DC ignition source. The heat and expanding gases resulting from this combustion process are directed to displace a piston or move a turbine blade, both of which can be connected to a crankshaft of the engine. As the piston is displaced or the turbine blade is moved, the crankshaft is caused to rotate. This rotation is then utilized to drive a device such as a transmission or a generator to propel a vehicle or to produce electrical power.

During engine operation, parts located proximate to the combustion chamber can be exposed to high stresses and temperatures as a result of the high combustion pressures and temperatures. Over time, these high stresses and temperatures can cause excessive wear of these parts. For example, the increased combustion temperatures can cause parts associated with a spark plug to undergo thermal deformation (e.g., creeping). When the spark plug parts experience creeping, combustion gas can escape past threads of the spark plug, causing deterioration of a seal and/or a gasket associated with the spark plug. Once the seal no longer functions properly, lubrication oil can leak past the threads of the spark plug and travel into the combustion chamber. Oil in the combustion chamber can lead to problems, such as engine detonation, which can often result in loss of production and increased repair costs.

One method of resolving the problems set forth above is to frequently retighten the spark plug. However, this may increase engine downtime and require additional labor time and costs. Another method of resolving the problems set forth above is to cool the spark plug to prevent creeping of the spark plug. One attempt at cooling a spark plug is disclosed in Japanese Patent Publication No. 61-138817 (“the '817 publication”) that issued to Hiroyuki et al. on Jun. 26, 1986. The '817 publication discloses an engine having a spark plug located within a cylinder head near a central part of a combustion chamber of the engine. The '817 publication further discloses that a drill hole is installed in a wall of the cylinder head to allow cooling water to flow from a water jacket in a cylinder block of the engine to the drill hole to provide cooling for an external threaded part of the spark plug. The cooling can help to prevent thermal deterioration of the spark plug.

Although the drill hole of the '817 publication may help to provide some cooling for the spark plug, it may still be less than optimal. Specifically, the drill hole only allows cooling water to reach a portion of the threaded part, which limits the amount of heat that can transfer from the spark plug to the cooling water. In addition, it may be difficult and expensive to drill additional holes in the cylinder head to provide an adequate cooling passage for the spark plug.

The disclosed spark plug assembly is directed to overcoming one or more of the problems set forth above and/or other problems of the prior art.

### SUMMARY

In one aspect, the present disclosure is directed to a spark plug assembly for an engine having a cylinder head at least partially defining a combustion chamber. The spark plug assembly may include a spark plug at least partially disposed in the cylinder head and configured to generate a spark inside the combustion chamber to ignite an air and fuel mixture. The spark plug assembly may also include an insert configured to receive the spark plug and at least partially form a cooling passage surrounding the spark plug.

In another aspect, the present disclosure is directed to a spark plug assembly for an engine having a cylinder head at least partially defining a combustion chamber. The spark plug assembly may include a spark plug at least partially disposed in the cylinder head and configured to generate a spark inside the combustion chamber to ignite an air and fuel mixture. The spark plug may include threads having a ratio of a thread length to a thread diameter of about 1.7.

In yet another aspect, the present disclosure is directed to a cylinder head assembly for an engine having a combustion chamber. The cylinder head assembly may include a cylinder head having a stepped bore. The cylinder head assembly may also include a spark plug at least partially disposed in the stepped bore and configured to generate a spark inside the combustion chamber to ignite an air and fuel mixture. The spark plug includes a plurality of external threads. The cylinder head assembly may further include a generally ring-shaped insert configured to engage the stepped bore and receive the spark plug. The insert may have a plurality of internal threads configured for direct engagement with the plurality of external threads of the spark plug. The cylinder head assembly may further include a cooling passage at least partially formed by the insert and the stepped bore.

### BRIEF DESCRIPTION OF THE DRAWINGS

FIG. 1 is a diagrammatic illustration of an exemplary disclosed engine;

FIG. 2 is a cross-sectional view illustration of an exemplary disclosed spark plug assembly that may be used in conjunction with the engine of FIG. 1;

FIG. 3 is a cross-sectional view illustration of another exemplary disclosed spark plug assembly that may be used in conjunction with the engine of FIG. 1; and

FIG. 4 is a cross-sectional view illustration of yet another exemplary disclosed spark plug assembly that may be used in conjunction with the engine of FIG. 1.

### DETAILED DESCRIPTION

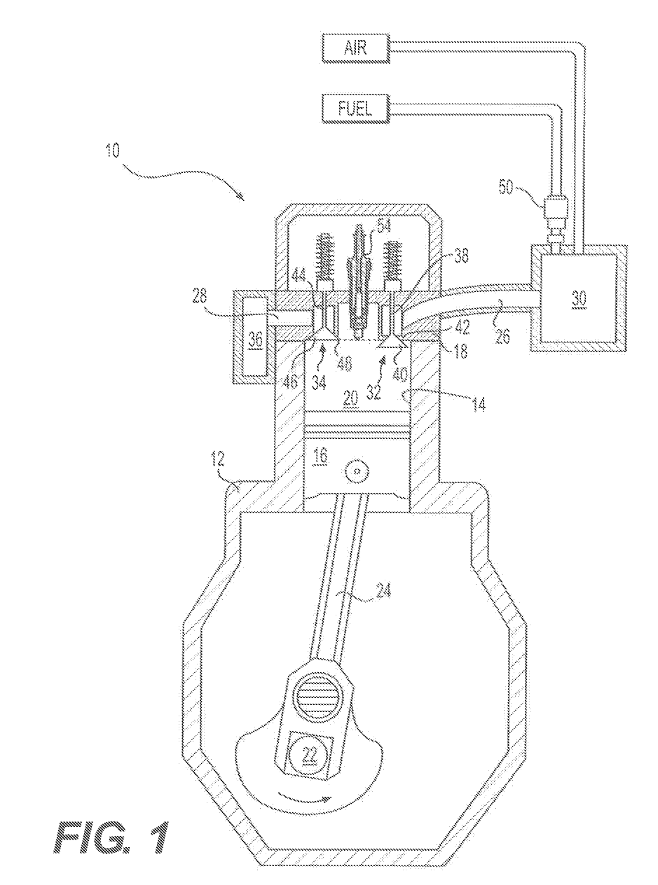

FIG. 1 illustrates an exemplary combustion engine 10. For the purposes of this disclosure, engine 10 is depleted and described as a four-stroke gaseous-fueled engine, for example a natural gas engine. One skilled in the art will recognize, however, that engine 10 may be any other type of combustion engine such as, for example, a gasoline-fueled engine or a dual-fuel (e.g., a natural gas and diesel-fueled) engine. Engine 10 may include an engine block 12 that at least partially defines one or more cylinders 14 (only one shown in FIG. 1). A piston 16 may be slidably disposed within each cylinder 14 to reciprocate between a top-dead-center (TDC) position and a bottom-dead-center (BDC) position, and a cylinder head 18 may be associated with each cylinder 14. Cylinder 14, piston 16, and cylinder head 18 may together define a combustion chamber 20. It is contemplated that engine 10 may include any number of combustion chambers 20 and that combustion chambers 20 may be disposed in an “in-line” configuration, in a “V” configuration, in an “opposing piston” configuration, or in any other suitable configuration.

Engine 10 may also include a crankshaft 22 that is rotatably disposed within engine block 12. A connecting rod 24 may connect each piston 16 to crankshaft 22 so that a sliding motion of piston 16 between the TDC and BDC positions within each respective cylinder 14 results in a rotation of crankshaft 22. Similarly, a rotation of crankshaft 22 may result in a sliding motion of piston 16 between the TDC and BDC positions. In a four-stroke engine, piston 16 may reciprocate between the TDC and BDC positions through an intake stroke, a compression stroke, a combustion or power stroke, and an exhaust stroke. It is also contemplated that engine 10 may alternatively be a two-stroke engine, wherein a complete cycle includes a compression/exhaust stroke (BDC to TDC) and a power/exhaust/intake stroke (TDC to BDC).

Cylinder head 18 may define an intake passageway 26 and an exhaust passageway 28. Intake passageway 26 may direct compressed air or an air/fuel mixture from an intake manifold 30, through an intake opening 32, and into combustion chamber 20. Exhaust passageway 28 may similarly direct exhaust gases from combustion chamber 20, through an exhaust opening 34, and into an exhaust manifold 36. In some embodiments, a turbocharger (not shown) may be driven by the exhaust exiting manifold 36 to compress the air entering manifold 30.

An intake valve 38 having a valve element 40 may be disposed within intake opening 32 and configured to selectively engage a seat 42. Intake valve 38 may be movable between a first position, at which valve element 40 engages seat 42 to inhibit a flow of fluid relative to intake opening 32, and a second position, at which valve element 40 is removed from seat 42 to allow the flow of fluid.

An exhaust valve 44 having a valve element 46 may be similarly disposed within exhaust opening 34 and configured to selectively engage a seat 48. Valve element 46 may be movable between a first position, at which valve element 46 engages seat 48 to inhibit a flow of fluid relative to exhaust opening 34, and a second position, at which valve element 46 is removed from seat 48 to allow the flow of fluid.

A series of valve actuation assemblies (not shown) may be operatively associated with engine 10 to move valve elements 40 and 46 between the first and second positions. It should be noted that each cylinder head 18 could include multiple intake openings 32 and multiple exhaust openings 34. Each such opening would be associated with either an intake valve element 40 or an exhaust valve element 46. Engine 10 may include a valve actuation assembly for each cylinder head 18 that is configured to actuate all of the intake valves 38 or all of the exhaust valves 44 of that cylinder head 18. It is also contemplated that a single valve actuation assembly could actuate the intake valves 38 or the exhaust valves 44 associated with multiple cylinder heads 18, if desired. The valve actuation assemblies may embody, for example, a cam/push-rod/rocker arm arrangement, a solenoid actuator, a hydraulic actuator, or any other means for actuating known in the art.

A fuel admittance device 50 may be associated with engine 10 to direct pressurized fuel into combustion chamber 20. Fuel admittance device 50 may embody, for example, an electronic valve situated at a location upstream of intake manifold 30. It is contemplated that admittance device 50 could alternatively embody a hydraulically, mechanically, or pneumatically actuated device that selectively pressurizes and/or allows pressurized fuel to pass directly into combustion chamber 20 or in another manner. The fuel may include a compressed gaseous fuel such as, for example, natural gas, propane, bio-gas, landfill gas, or hydrogen. It is also contemplated that the fuel may be liquefied, for example, gasoline, diesel, methanol, ethanol, or any other liquid fuel may be injected into combustion chamber 20, and that an onboard pump (not shown) may be required to pressurize the fuel.

The amount of fuel output by admittance device 50 may be associated with a ratio of air-to-fuel introduced into combustion chamber 20. For example, in the disclosed embodiment. It is desirable to introduce a stoichiometric mixture of air and fuel (mixture having just enough air to completely burn off an amount of fuel) into combustion chamber 20. However, in alternative embodiments, if it is desired to introduce a ban mixture of air and fuel (mixture having a relatively low amount of fuel compared to the amount of air) into combustion chamber 20, admittance device 50 may remain In an injecting position for a shorter period of time (or otherwise be controlled to inject less fuel per given cycle) than if a rich mixture of fuel and air (mixture having a relatively large amount of fuel compared to the amount of air) is desired. Likewise, if a rich mixture of air and fuel is desired, admittance device 50 may remain in the injecting position for a longer period of time (or otherwise be controlled to inject more fuel per given cycle) than if a lean mixture is desired.

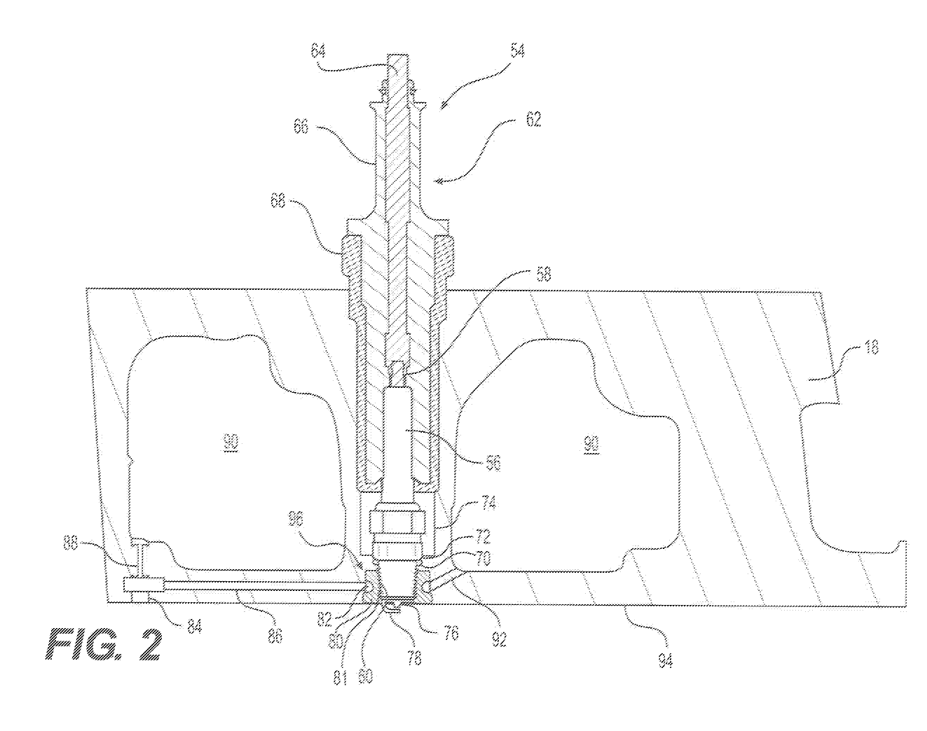

As shown in FIG. 2, engine 10 may be equipped with a spark plug assembly 54 configured to facilitate ignition of the air/fuel mixture within combustion chamber 20. Specifically, the air/fuel mixture may be ignited by a flame jet propagating into combustion chamber 20 as piston 16 nears TDC during the compression stroke, as piston 16 leaves TDC during the power stroke, or at another appropriate time. The flame jet may be generated by one or more components associated with spark plug assembly 54.

Spark plug assembly 54 may include a spark plug 56 having an electrode 58 protruding from a first end and a plurality of external threads 60 substantially surrounding a periphery of spark plug 56 at an opposing second end. Electrode 58 may extend through a body of spark plug 56 and at least partially into combustion chamber 20. Threads 60 may be configured for direct engagement with cylinder head 18 and/or one or more components of spark plug assembly 54.

Spark plug assembly 54 may also include an extension portion 62 having an electrode 64, an insulator 66, and an outer shell 68. Electrode 64 may be connected to electrode 58 at a first end and connected to a power supply (not shown) at an opposing second end. Insulator 66 may be disposed between electrode 64 and outer shell 68 to electrically isolate electrode 64 from outer shell 68. Outer shell 68 may be a generally cylindrical body fabricated from an electrically conductive material. In some embodiments, a gasket 70 may abut a seating surface 72 of spark plug 56 resting on a bottom surface of a spark plug well 74. Gasket 70 may provide a tight seal between cylinder head 18 and spark plug 56 to block unintended leakage of oil and/or gases into or out of combustion chamber 20.

Electrodes 58, 64 may be fabricated from an electrically conductive metal such as. for example, tungsten, iridium, silver, platinum, and gold palladium, and be configured to direct current from the power supply to ionize (i.e., create a corona within) the air/fuel mixture of combustion chamber 20 in order to ignite the air/fuel mixture. In the disclosed embodiment, a portion of electrode 58 extends at least partially into combustion chamber 20 to form a spark end 76. Spark end 76 may be positioned proximate to a ground electrode 78, such that current from the power supply may travel through electrode 58 and then from spark end 76 to ground electrode 78, in order to create a spark to ignite the air/fuel mixture within combustion chamber 20.

In the embodiment shown in FIG. 2, spark plug assembly 54 may also include a generally ring-shaped insert 80 configured to facilitate cooling of spark plug 56. Specifically, insert 80 may include an outer, annular recess at least partially forming a cooling passage 82 that substantially surrounds insert 80. Cooling passage 82 may entirely surround a periphery of insert 80, such that it facilitates the transfer of thermal energy away front spark plug 56. Coolant, such as glycol, water, a water/glycol mixture, or another coolant known In the art may be directed into cooling passage 82 from one or more additional cooling components of engine 10.

For example, coolant may enter cylinder head 18 through an inlet cooling passage 84, where the coolant is then divided into two smaller cooling passages 86, 88 in a lower portion of cylinder head 18. Cooling passage 88 may direct coolant to a main cooling jacket 90 disposed within cylinder head 18, while cooling passage 86 may direct coolant to cooling passage 82. After exiting cooling passage 82, coolant may be redirected to main cooling jacket 90 via cooling passage 92. Cooling passage 92 may be angled at about 20-25° with respect to a bottom (e.g., firedeck) surface 94 of cylinder head 18 to allow coolant to flow at a constant rate within cylinder head 18. In some embodiments, cooling passage 86 may have a substantially larger diameter (i.e., allow a substantially greater volumetric flow rate) than cooling passage 88. This configuration may allow coolant to flow into main cooling jacket 90 at substantially the same rate as in cylinder head configurations without cooling passage 82. Thus, the addition of cooling passage 82 may not substantially affect the flow rate of coolant within cylinder head 18.

During installation of spark plug assembly 54, an outer, radial surface of insert 80 may engage a stepped bore 96 formed within cylinder head 18, such that insert 80 provides a tight seal with cylinder head 18 to prevent coolant leakage into combustion chamber 20 and/or spark plug well 74. In some embodiments, the engagement between stepped bore 96 and the outer, radial surface of insert 80 may be a tight interference fit (i.e. press-fit) that provides sealing above and below cooling passage 82. In addition, insert 80 may have a plurality of internal threads 81 formed on an inner, radial surface of insert 80. Threads 81 may be configured for direct engagement with external threads 60 of spark plug 56. During assembly, insert 80 may be press-fit into stepped bore 96, and then, spark plug 56 may be screwed into insert 80 via threads 60, 81.

In the disclosed embodiment, insert 80 is preferably manufactured from a durable, heat-resistant, and thermally-conductive material, such as a gray iron. Cylinder head 18 may also be made of gray iron, which may allow insert 80 to expand and contract at substantially die same rate as cylinder head 18. It is contemplated, however, that insert 80 may be made of other sui table materials, if desired. Additionally, it should be noted that, in the disclosed embodiment insert 80 is a component separate from cylinder head 18 and spark plug 56. However, in other embodiments, insert 80 may alternatively be integral with cylinder head 18 or spark plug 56.

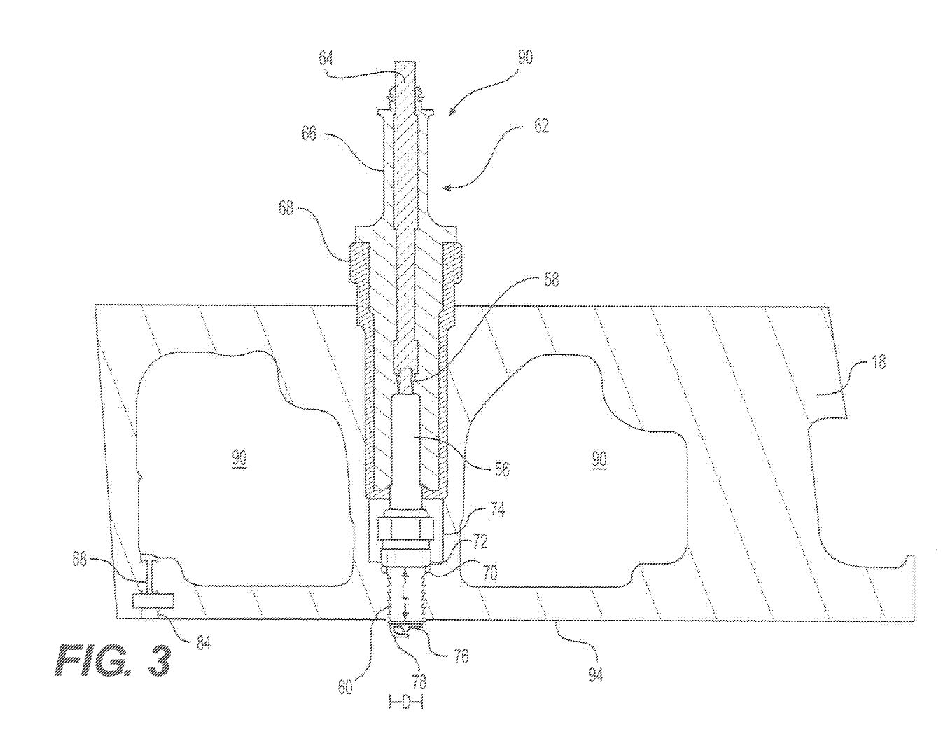

FIG. 3 may provide another exemplary disclosed spark plug assembly 98. In contrast to spark plug assembly 54, spark plug assembly 98 may not include an insert surrounding spark plug 56. Instead, in order to facilitate cooling of spark plug 56, the spark plug 56 in spark plug assembly 98 may have threads 60 with an increased thread length. Specifically, threads 60 may have a thread length-to-diameter ratio of about 1.7. In one embodiment, threads 60 may have a thread length L of about 30 mm and a thread diameter D of about 18 mm. The term “about” as used herein is intended to account tor normal manufacturing tolerances. It should be noted that in all other aspects, spark plug assembly 98 may be substantially the same as spark plug assembly 54.

The increased thread length in spark plug assembly 98 may provide a larger contact area for spark plug 56 to transfer heat to cylinder head 18, thereby allowing spark plug 56 to cool down at a fester rate. In addition, by moving seating surface 72 of spark plug 56 higher up within cylinder head, and therefore further away from combustion chamber 20, the components located in this particular region of spark plug 56 (e.g., gasket 70 and seating surface 72) may experience lower temperatures. As a result, these components may experience less thermal deformation (e.g., creeping).

It should be noted that spark plugs having threads with a thread length-to-diameter ratio that is lower than about 1.5 experience substantially lower cooling rates. On the other hand, spark plugs having threads with a thread length-to-diameter ratio that is greater than about 2.0 are unnecessarily large in size and do not provide substantially greater cooling rates.

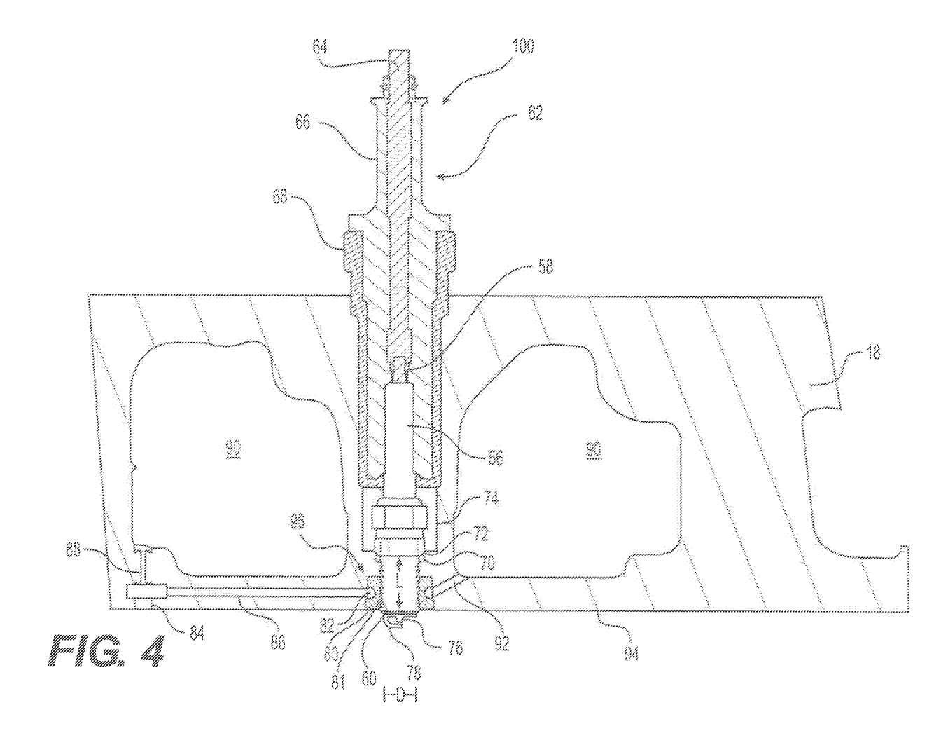

FIG. 4 illustrates yet another exemplary disclosed spark plug assembly 100. Spark plug assembly 100 may be substantially the same as spark plug assembly 54, with the addition of an increased thread length as provided in spark plug assembly 98. Specifically, like in spark plug assembly 98, the spark plug 56 in spark plug assembly 100 may have threads 60 with a thread length-to-diameter ratio of about 1.7. Spark plug assembly 100 may combine the two cooling methods discussed in spark plug assembly 54 and spark plug assembly 98 and receive substantially the same benefits to provide even greater cooling of spark plug 56.

### INDUSTRIAL APPLICABILITY

The disclosed spark plug assembly may be implemented into any engine application where engine cooling is utilized. In one embodiment, the disclosed spark plug assembly may include a cooling passage formed between a spark plug insert and a cylinder head to provide increased cooling to the spark plug. In another embodiment, the disclosed spark plug assembly may have an increased thread length associated with the spark plug to also provide increased cooling to the spark plug. In yet another embodiment, the disclosed spark plug assembly may combine the spark plug insert with the increased thread length to provide even greater cooling to the spark plug. The method for directing coolant through the cylinder head will now be described below.

Referring to FIGS. 2 and 4, coolant may be directed into cylinder head 18 from one or more additional cooling components of engine 10 via inlet cooling passage 84. Within cylinder head 18, the coolant may be divided into cooling passages 86, 88. For example, coolant may be divided into a first flow stream into cooling passage 86 and into a second, smaller flow stream into cooling passage 88. The coolant from cooling passage 88 may flow into main coolant jacket 90. The coolant from cooling passage 86 may flow into cooling passage 82 surrounding insert 80. The coolant flowing through cooling passage 82 may absorb thermal energy from cylinder head 18, insert 80, and/or spark plug 56. The coolant may then exit cooling passage 82 through cooling passage 92 and continue to main coolant jacket 90.

It will be apparent to those skilled in the art that various modifications and variations can be made to the disclosed spark plug assembly. Other embodiments will be apparent to those skilled in the art from consideration of the specification and practice of the disclosed spark plug assembly. It is intended that the specification and examples be considered as exemplary only, with a true scope being indicated by the following claims and their equivalents.

What is claimed is:

1. A spark plug assembly for an engine having a cylinder head at least partially defining a combustion chamber, comprising:
a spark plug at least partially disposed in the cylinder head and configured to generate a spark inside the combustion chamber to ignite an air and fuel mixture; and
an insert configured to receive the spark plug and at least partially form a cooling passage surrounding the spark plug.

2. The spark plug assembly of claim 1, wherein the insert is a generally ring shaped body having an outer, annular recess at least partially forming the cooling passage.

3. The spark plug assembly of claim 2, wherein the cooling passage substantially surrounds a periphery of the insert.

4. The spark plug assembly of claim 2, wherein the insert is made of gray iron.

5. The spark plug assembly of claim 2, wherein the insert is configured to be pressed into a stepped bore within the cylinder head with an interference fit.

6. The spark plug assembly of claim 5, wherein the annular recess of the insert is a first annular recess forming a first side of the cooling passage, and the stepped bore includes a second annular recess forming a second side of the cooling passage.

7. The spark plug assembly of claim 1, wherein the spark plug includes:
a first electrode extending through a body of the spark plug and at least partially into the combustion chamber; and
a plurality of external threads substantially surrounding a periphery of the spark plug.

8. The spark plug assembly of claim 7, wherein the insert includes a plurality of internal threads configured for direct engagement with the plurality of external threads of the spark plug.

9. The spark plug assembly of claim 7, further including an extension portion including:
a second electrode connected to the first electrode;
a generally cylindrical outer shell; and
an insulator disposed between the second electrode and the outer shell.

10. The spark plug assembly of claim 7, further including a gasket configured to engage a seating surface of the spark plug and prevent unintended leakage into or out of the combustion chamber.

11. A spark plug assembly for an engine having a cylinder head at least partially defining a combustion chamber, comprising:
a spark plug at least partially disposed in the cylinder head and configured to generate a spark inside the combustion chamber to ignite an air and fuel mixture,
wherein the spark plug includes threads having a ratio of a thread length to a thread diameter of about 1.7.

12. The spark plug assembly of claim 11, wherein the threads have a thread length of about 30 mm.

13. The spark plug assembly of claim 11, wherein the threads nave a thread diameter of about 18 mm.

14. A cylinder head assembly for an engine having a combustion chamber, comprising:
a cylinder head having a stepped bore;
a spark plug at least partially disposed in the stepped bore and configured to generate a spark inside the combustion chamber to ignite an air and fuel mixture, the spark plug including a plurality of external threads;
a generally ring-shaped insert configured to engage the stepped bore and receive the spark plug, the insert having a plurality of internal threads configured for direct engagement with the plurality of external threads of the spark plug; and
a cooling passage at least partially formed by the insert and the stepped bore.

15. The cylinder head assembly of claim 14, wherein the plurality of external threads of the spark plug nave a ratio of a thread length to a thread diameter of about 1.7.

16. The cylinder head assembly of claim 14, wherein the cooling passage is a first cooling passage, and the cylinder head assembly further includes an inlet cooling passage configured to direct coolant to a second cooling passage and a third cooling passage.

17. The cylinder head assembly of claim 16, wherein:
the second cooling passage is configured to direct coolant to a main cooling jacket associated with die cylinder head; and
the third cooling passage is configured to direct coolant to the first cooling passage.

18. The cylinder head assembly of claim 17, wherein the third cooling passage has a diameter that is larger than the diameter of the second cooling passage.

19. The cylinder head assembly of claim 17, wherein the first cooling passage is configured to direct coolant to a fourth cooling passage to redirect the coolant to the main cooling jacket.

20. The cylinder head assembly of claim 19, wherein the fourth cooling passage is angled at about 20-25° with respect to a bottom surface of the cylinder head.
